(19) United States
(12) Patent Application Publication
(10) Pub. No.: US 2025/0360610 A1
(43) Pub. Date: Nov. 27, 2025

(54) Mobile Sensing Robots Having Multipoint Sensing Systems for Sensing Characteristics of Materials, and Related Systems, Methods, and Software

(71) Applicant: University of Vermont and State Agricultural College, Burlington, VT (US)

(72) Inventors: Dryver Huston, South Burlington, VT (US); Tian Xia, Burlington, VT (US); Yi Liu, Burlington, VT (US); Alireza Fath, Burlington, VT (US); Nicholas Hanna, Burlington, VT (US)

(21) Appl. No.: 19/219,315

(22) Filed: May 27, 2025

Related U.S. Application Data
(60) Provisional application No. 63/652,107, filed on May 27, 2024.

(51) Int. Cl. B25J 5/00; B25J 19/02

(52) U.S. Cl. CPC B25J 5/007; B25J 19/02

(57) ABSTRACT

Mobile sensing robots having multipoint sensing systems that include multiple probes for making measurements of material characteristics and/or other conditions. The probes may be deployed on traction elements, such as legs, wheels, and/or tracks, of a traction system that can move the robot on a surface of a material. The probes may be deployed on a probe deployment system that operates independently of any traction system provided. The mobile sensing robot may include a mobility system, such as an aerial mobility system and/or a submissible mobility system, in addition to or in place of the traction system. The probes may be of any one or more of a variety of types, such as vibration-sensing probes, stimulus electrode, measuring electrodes, temperature sensors, and humidity sensors, among many other types.

### RELATED APPLICATION DATA

The present application claims the benefit of priority to U.S. Provisional Patent Application Ser. No. 63/652,107, filed on May 27, 2024, and titled “MOBILE SENSING ROBOTS HAVING MULTIPOINT SENSING SYSTEMS FOR SENSING CHARACTERISTICS OF MATERIALS, AND RELATED SYSTEMS, METHODS, AND SOFTWARE”, which is incorporated herein by reference in its entirety.

### FIELD

The present disclosure generally relates to the field of remote sensing of characteristics of materials. In particular, the present disclosure is directed to mobile sensing robots having multipoint sensing systems for sensing characteristics of materials, and related systems, methods, and software.

### BACKGROUND

The testing of materials in situ has many important applications. For example, testing concrete, steel, and other construction materials is important for monitoring and assessing the states of the materials and, consequently, the safety of the buildings, bridges, and other structures being monitored and assessed. For concrete, some forms of in-situ testing include vibration testing to test the soundness of the concrete, electrical resistance testing for testing integrity of steel reinforcement within the concrete, and electrical capacitance testing for testing moisture content of the concrete. Current testing equipment for performing these tests are typically embodied in handheld portable units that a user must manually move to each testing location.

### SUMMARY

In an implementation, the present disclosure is directed to a mobile sensing robot for traversing a surface of a material. The mobile sensing robot includes a body, a mobility system engaged with the body, the mobility system designed and configured to move the mobile sensing robot relative to the surface when the mobile sensing robot is deployed for use; and a multipoint sensing system operatively coupled to the body, the multipoint sensing system including a plurality of probes each configured to be intermittently deployed into contact with the surface at corresponding respective spaced-apart locations on the surface so that the probes can be used to acquire measurement data of a characteristic of the material; and a control system located aboard the mobile sensing robot and operatively coupled with: the traction system so as to control movement of each of the plurality of traction elements; and the multipoint sensor system so as to control operation of the plurality of probes.

### BRIEF DESCRIPTION OF THE DRAWINGS

For the purpose of illustration, the accompanying drawings show aspects of one or more embodiments of the disclosure. However, it should be understood that the scope of this disclosure is/are not limited to the precise arrangements and instrumentalities shown in the drawings, wherein:

FIG. 1 is a high-level diagram illustrating a mobile-sensing-robot system made in accordance with the present disclosure;

FIG. 2A is a side view of an example wheel-type traction element of the present disclosure having a smooth traction surface, showing example probe locations;

FIG. 2B is a side view of an example wheel-type traction element of the present disclosure having a treaded traction surface, showing example probe locations;

FIG. 3 is a view of treads of a portion of a track-type traction element of the present disclosure, showing example probe locations;

FIG. 4 is an isometric view of a mobile sensing robot made in accordance with the present disclosure;

FIG. 5A is a graph of sensor readings (volts) versus time (seconds) for two of the piezoelectric-type vibration sensors of the mobile sensing robot of FIG. 4 standing on a steel surface; and

FIG. 5B is a graph of sensor readings (volts) versus time (seconds) for two of the

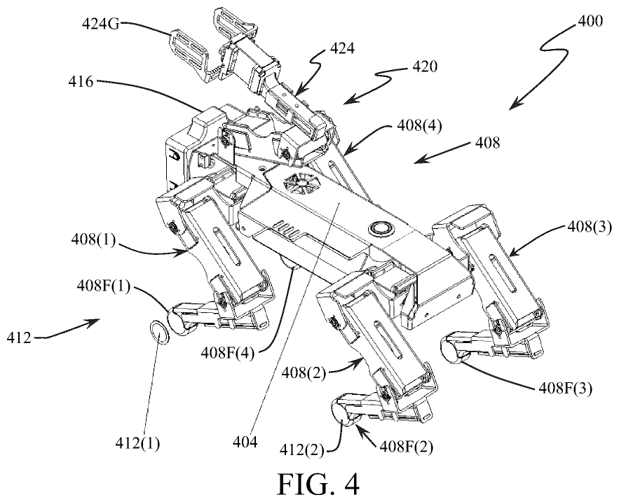

piezoelectric-type vibration sensors of the mobile sensing robot of FIG. 4 standing on a plastic surface.

### DETAILED DESCRIPTION

The entire contents of the appended claims are incorporated into this Detailed Description section by reference and should be treated as if originally presented herein.

Unless noted otherwise, the modifiers “first”, “second”, “third”, “fourth”, and the like, do not denote any particular order or importance, location, priority, etc. Rather, these modifiers are used simply to differentiate elements that are the same as or similar to one another in a set of two or more of such elements.

### GENERAL

In some aspects, the present disclosure is directed to mobile sensing robots that each include one or more multipoint sensing systems for sensing one or more corresponding characteristics of any suitable material. The material may be any suitable material, such as concrete, steel, railroad ballast, rip-rap, structural fill, composite, and wood, among others. Fundamentally, there is no limitation on the type of material being tested other than it be compatible with the testing being performed. The form of the mobile sensing robot may be any suitable form, such as, but not limited to: a terrestrial form (e.g., legged, wheeled, tracked, etc.); an aerial form, such as unpersoned aerial vehicle (UAV) (e.g., a propellered drone, a micro-insect, etc.); and a submersible form, such as an autonomous underwater vehicle (AUV), a remotely operated vehicle (ROV), etc.; among others, and any combination thereof. Example multipoint sensing systems for a mobile sensing robot of the present disclosure include, but are not limited to, multipoint vibration-sensing systems having multiple spaced-apart vibration sensors, electrical-resistance sensing systems having one or more stimulus electrodes and one or more measurement electrodes, electrical-capacitance sensing systems having one or more stimulus electrodes and one or more measurement electrodes, multipoint temperature-sensing systems having multiple temperature sensors at differing locations, multipoint ultrasonic-sensing systems having multiple ultrasound transducers, multipoint pressure sensing systems having multiple pressure sensors, multipoint total-dissolved-solids (TDS) sensing systems having multiple TDS sensors, and multipoint humidity-sensing systems having multiple humidity sensors at differing locations, among others. In some embodiments, only one of each of the above-identified sensors may be provided, with the multipoint functionality accomplished by moving the mobile sensing robot to differing locations.

For the sake of convenience, the term “probe” is used herein and in the appended claims to denote a moveable structure to or in which one or more sensors, one or more stimulus electrodes, and/or one or more measuring electrodes is attached or integrated. Examples of probes of the present disclosure are provided below. Those skilled in the art will understand other multipoint sensing systems that can be deployed on a mobile sensing robot of the present disclosure, especially after reading this entire disclosure.

As described in detail below, each mobile sensing robot includes a body and a mobility system. The body may take any suitable form, such as a chassis-based form, an open or closed spaceframe form, or a unibody form, among others. Generally, the body typically provides a platform for the mobility system and each of the one or more multipoint sensing systems. Depending on the embodiment, that body may also provide a platform, housing, support, for one or more additional components, such as, but not limited to, an onboard control system, and onboard navigation controller, one or more imaging systems (e.g., video, forward-looking radar), a laser-ranging system, light detection and ranging, wireless communications system, wired communications system, onboard computing hardware (e.g., one or more processors and associated memory), one or more measurement sensors not part of an onboard multipoint sensing system, a sounding generator for inducing vibrations in the material under test, and one or more onboard power sources (e.g., battery (ies), fuel cell(s), etc.), among other things, and any combination thereof.

The mobility system may be, for example, any suitable mobility system such as an airborne mobility system for moving the mobile sensing robot through the air, a submersible propulsion system for moving the mobile sensing robot through water or other liquid (e.g., liquid petroleum products, liquid chemical products, sewage, etc.), or a traction system for moving the mobile sensing robot on one or more surfaces, including a surface of the material being tested, or any combination thereof. The mobility system allows the mobile sensing robot to be deployed to a remote location and/or moved from testing location to testing location in any of a variety of manners, such as in a human-guided fashion, a semi-automated fashion, or a fully automated fashion, among others. In some embodiments, the mobility system may be a mobility system specially adapted for a specific type of deployment, such as on steeply inclined or vertical surfaces. In some embodiments, the traction system may be more generally designed for deployments having various types of surfaces. In this connection, example surfaces include solid surfaces, smooth surfaces, rough surfaces (e.g., formed by railroad ballast and like materials), uneven surfaces, hard surfaces, and soft surfaces, among many others.

In some embodiments of a traction system, the traction system may include two or more traction elements of any suitable type(s). For example, the traction elements may be ambulatory legs having corresponding feet for intermittently engaging a surface during ambulation, wheels having surface-engaging elements (e.g., smooth surfaces or treads), and tracks (e.g., chain- or belt-type) having surface-engaging elements (e.g., smooth surfaces or treads), among others, and any combination of these traction elements. The traction elements may be driven by one or more suitable actuators (e.g., electromechanical, pneumatic, hydraulic, electromagnetic, etc.) or motors (e.g., stepper motor, servomotor, etc.), such an any conventional actuators or conventional motors used for like elements in conventional robots.

Each traction element may include one or more contact surfaces for contactingly engaging a surface to which the corresponding mobile sensing robot is deployed, with such contact surfaces being designed and configured to provide characteristics (e.g., friction, compliance, treading, etc.) suitable for allowing the traction system to move the mobile sensing robot on each surface at issue. In some embodiments, each traction element may include one or more engagement-enhancing features for enhancing the engagement of the traction element with certain types of surfaces. Examples of engagement-enhancing features include, but are not limited to, electromagnets for traversing surfaces of ferromagnetic materials, suction devices for traversing relatively smooth surfaces, and gripping elements for gripping and releasing graspable features the form a traversed surface or are otherwise present on or in the traversed surface. Other types of engagement-enhancing features are possible and can be tailored to the use application at hand.

In some embodiments of an airborne mobility system, the airborne mobility system may be, for example, of a helicopter-rotor-type or of a flapping-wing-type, such as used in robotic micro-insects. In some embodiments, a mobile sensing robot of the present disclosure having an airborne mobility system may have passive landing gear, e.g., legs, feet, wheels, etc., or a complementary traction system. In either case, one or more of the probes may be integrated into or otherwise be coupled to corresponding elements of the landing gear or traction system.

In some embodiments, of a submersible propulsion system, the submersible propulsion system may be, for example, of a propeller-type or of a jet type. In such embodiments, the mobile sensing robot will typically further include a traction system and/or a probe deployment system for deploying the probes for acquiring measurements of the relevant type. As those skilled in the art will readily appreciate, mobile sensing robots having submersible propulsion systems can be deployed for any one or more of a variety of purposes, such as, but not limited to, inspecting submerged structures or submerged parts of structures (e.g., storage tanks, sewage-processing tanks and basins, offshore structure, ship hulls, etc.) and/or measuring one or more aspects of the relevant liquid (e.g., temperature, turbidity, contamination, etc.), among other things.

In some embodiments, each probe of the set of multiple probes deployed on the mobile sensing robot is movable relative to the body, in some cases independently of one or more of the remaining multiple probes and in some cases in concert with one or more of the remaining multiple probes. In some embodiments, at least some of the probes are integrated into one or more of the traction elements of the traction system. As examples: when a traction element is a leg having a surface-contacting foot, one or more probes may be integrated into or otherwise coupled with the foot and moveable therewith when the leg is driven; when a traction element is a wheel, one or more probes may be integrated into or otherwise coupled to the wheel and moveable therewith when the wheel is driven, and when a traction element is a track, one or more probes may be integrated into or otherwise coupled to the track and moveable therewith when the track is driven. As noted above, in each case, the portion of the traction element that contacts a surface may or may not have treads, depending on the design.

In a traction element having treads, one or more of the probes may be integrated into or otherwise coupled to one or more corresponding treads. In an example having multiple probes on the same traction element, a track may have multiple electrodes, in spaced-apart locations along the track, with each electrode being either of a dedicated type (e.g., stimulus or measurement) or a switchable type (e.g., switchable between stimulus and measurement). In some embodiments, the known distance between fixed probes on a single track can be useful in the measurement being taken. In other examples involving a track as a traction element, multiple vibration-sensing probes may be provided along the track, for example, with the multiple probes being individually addressable as desired to take simultaneous vibration measurements at specific desired locations. In some embodiments, multiple vibration probes can be provided along with electrode probes. In an example involving a pair of laterally spaced tracks as the traction elements of a mobile sensing device, all of the probes on one of the tracks may all be of the same type (e.g., stimulus electrodes) and all of the probes on the other of the tracks may be all of a different type (e.g., measurement probes). For tracked embodiments having relatively long regions of contact with a surface where at least one measurement is to be taken, coupled with the fact that precisely locating a track-based probe can be challenging with tracks, can make it beneficial to include multiple probes along the entire length of the track. For a wheel-type traction element, multiple probes can be provided on the surface-contacting portion(s) in a manner similar to a track-type traction element as just described.

In some embodiments, one or more probes may not be attached to any traction element. Rather, one or more probes may be integrated with or otherwise coupled to a corresponding probe deployer that is operable independently of the traction system. In such embodiments, the traction system moves the corresponding mobile sensing robot to a desired location on a testing surface, and then, when the mobile sensing robot is in the desired or necessary location, one or more probe deployers may be activated to engage one or more probes to the testing surface for testing. In an example, the probe deployer includes a linear actuator having a probe-support bar, distal from the body and having a longitudinal axis perpendicular to the extension axis of the linear actuator, that the linear actuator moves away from and toward the body upon command. In this example, the probe-support bar has a probe at each of its longitudinal ends, with the probe-support bar being attached to the linear actuator in its central region. When one or more measurements are to be taken, the linear actuator, initially in a retracted position, is controlled to extend in a direction toward the measurement surface so as to firmly place the probes into operative contact with the measurement surface. As another example, a plurality of probe deployers may be configured in the fashion of deployable outriggers, such as deployable outriggers the same as or similar to actuatable outriggers commonly found on construction/work/emergency vehicles such as mobile cranes, backhoes, bucket trucks, and ladder trucks, among others.

In some embodiments, when the measurement surface is horizontal or reasonably horizontal, the one or more probe deployers may ensure proper contact of the probes with the measurement surface by lifting at least a portion of the body of the mobile sensing robot off of the measurement surface. In some embodiments, when the measurement surface is in any orientation and when one or more traction elements of the traction system include one or more engagement-enhancing features, such as suction devices or electromagnets, the one or more probe deployers may be operated in concert with the one or more engagement-enhancing features to increase the amount of force that the probes can apply to the measurement surface, thereby increasing the contact force therebetween. This can be particularly useful for vibration probes and/or for use on measurement surfaces that are not horizontal.

The sensor(s) and/or stimulator(s) used on the probes may be of any type suitable for the type(s) of measurement(s) at issue and the composition(s) of the measurement surface(s) with which the corresponding mobile sensing robot is designed to be used. For example, for vibration sensing, each sensor may be a piezoelectric-type vibration sensor, such as a patch-type sensor applied to a surface-contacting portion of the corresponding traction element. For electrical testing (e.g., resistance and capacitance), the sensor(s) and stimulator(s) may be electrodes designed and configured to make suitable contact with the measurement surface. Such electrodes are known, for example, in the field of conventional electrical testing of concrete. For temperature sensing, each temperature sensor may be any suitable contact or non-contact type temperature sensor, for example, of any conventional design. For ultrasonic testing, each ultrasound transducer may be any suitable transducer, such as a conventional ultrasound transducer. In some embodiments, any sensor or stimulator may be controllably moveable relative to the corresponding probe, for example, so as to be movable between a use position and a stowed position, with the stowed position being provided to protect the sensor/stimulator from damage while not in use. In an example, any sensor, stimulator, or transducer may be located within a recess within the corresponding probe. In the context of tread of a wheel or track functioning as a probe, each sensor, stimulator and/or transducer may be moveably located within a recess in the tread. In the context of a foot of a leg functioning as a probe, each sensor, stimulator and/or transducer may be moveably located within a recess in the foot. In some embodiments, any sensor, stimulator, or probe may provide the surface-engaging portion of the corresponding probe/traction element.

In some aspects, the present disclosure is directed to methods of acquiring at least one measurement using a multipoint sensing system. The method includes causing a mobile sensing robot to traverse at least one surface to reach a first measurement location on a surface of a material having at least one characteristic to be measured using the multipoint sensing system. In some embodiments, the mobile sensing robot is caused to traverse the at least one surface by receiving navigation commands from a human pilot located remotely from the mobile sensing robot. In some embodiments, the mobile sensing robot may include one or more imaging devices (e.g., a visible-light camera, an infrared camera, a forward-looking radar, a laser-ranging device, etc.) and/or one or more locating devices (e.g., a global-positioning system (GPS) device, a local positioning device (e.g., that operates with a set of local triangulation markers), etc.) that provide(s) information to the pilot to allow the pilot to issue appropriate navigation commands to a control system onboard the mobile sensing robot that operates a mobility system of the mobile sensing robot. The mobile sensing robot may receive navigation commands wirelessly or via a tether or umbilical.

In some embodiments, the mobile sensing robot may include a semi-autonomous controller that receives gross navigation commands, such as “proceed to location X”, with the semi-autonomous navigation controller using one or more onboard navigation sensors, such as any one or more of the sensors noted above, to auto-navigate to location X. In some embodiments, the mobile sensing robot may include an autonomous navigation controller that can seek and find the first navigation locations. For example, an autonomous navigation controller may be programmed to seek and find a target feature, for example, based on image recognition. In this example, an image of the target feature may be input into the autonomous navigation controller, which the autonomous navigation controller then seeks and finds based on feature recognition/image matching algorithms. Many algorithms for automatedly performing feature recognition/image matching are known, and any one or more of these can be used to implement autonomous navigation in a mobile sensing robot of the present disclosure. In another example, a precise location of a target feature may be input into an autonomous navigation controller using any suitable local or global coordinate system, such as a GPS coordinate system, among others, some of which are mentioned above. Those skilled in the art will readily appreciate the variety of ways to cause a mobile sensing device to navigate to a desired first measurement location, with the foregoing examples being just a few of such ways.

In some embodiments, autonomous navigation may be based on measurements that the mobile sensing robot acquires. For example, three or more vibration-sensing probes may be used to sense directionality relative to vibrations in the material underneath the mobile sensing robot, and the control system may be configured to automatedly cause the mobile sensing robot to move in a desired direction based on the directionality. For example, the vibrations may be caused by an external vibration source, and the control system may be configured to move the mobile sensing robot either toward or away from the vibration source. In another vibration-sensing example, vibration measurements at differing locations as the mobile sensing robot moves may be used to determine a direction of travel for the mobile sensing robot. For example, the control system may first control the mobile sensing robot to move in differing directions, e.g., from a central point, and take one or more vibration measurements at different locations resulting from the movements. The control system may compare the differing sets of vibration measurements to determine the direction to move to achieve a certain goal. For example, if the goal is to assess the soundness, or lack thereof, of the material being traversed, the control system may move the mobile sensing device in a direction of decreasing or increasing soundness, perhaps creating a soundness map in conjunction therewith. In a further example using vibrating sensing, the control system may use one or more non-vibration sensors to determine a direction of movement for the mobile sensing robot. For example, in a burning building, the control system may use a heat sensor (e.g., thermal imager or standoff thermometer) to sense a source of heat and cause the mobile sensing robot to move toward the heat source and take soundness readings along the way of the movement. This technique can be used in a variety of settings, such as when firefighters/rescue workers are inside a burning building and they need to avoid unsound flooring as they move through the building. Those skilled in the art will readily appreciate that these are just a few examples of many ways that a control system may cause a mobile sensing robot of the present disclosure to operate.

When the mobile sensing robot is at a measurement location, the multipoint sensing system is activated to take one or more measurements of at least one of the characteristics of the material at the measurement location. The activation of the multipoint sensing system may include simply controlling one or more probes to acquire one or more measurements and/or to apply one or more stimuli in conjunction with acquiring the measurement(s). This manner of activation can occur, for example, when the probes are integrated into traction elements and are located and oriented properly for taking one or more measurements and/or providing one or more stimuli.

However, in some embodiments, one or more of the probes may need to be moved and/or oriented for taking one or more measurements and/or providing one or more stimuli. When a probe is integrated with or otherwise coupled to a traction element, such movement and/or orientation may be achieved by operating that traction element. For example, if the traction element is an articulating leg and the probe is integrated into a foot of the leg, the control system may cause the traction system to control movement of the leg to achieve the proper desired location and/or orientation of the probe. When a probe is not integrated with or otherwise coupled to a traction element, but rather is moved by a probe deployer, the control system may operate the probe deployer to place that probe into the proper locations and/or orientation for making a measurement or providing a stimulus. When each probe is in the proper location and/or orientation, the control system may cause the measurement system to acquire one or more measurements.

As noted above, when one or more of the probes are vibration-sensing probes, the sensing robot may include a sounding generator that induces vibrations into the material being tested. In such embodiments, the control system, in conjunction with controlling the measurement system to make one or more vibration measurements, controls the sounding generator to induce the vibrations into the material. Example sounding generators include a leg traction element (e.g., controlled to provide a stomp-type impact with the surface of the material) or a separate mechanism, such as a weight-drop type mechanism, a pneumatic mechanism, an exploding-charge mechanism, or a hammer mechanism, among others.

Any control methods needed to operate a mobile sensing device of the present disclosure, such as measurement control methods, probe positioning/orienting control methods, navigation methods, image recognition/feature detection methods, mobility system control methods, etc., may be performed by any suitable combination of hardware and software. Examples of hardware include, but are not limited to, one or more processors of any suitable type (e.g., FPGA, general purpose, ASIC, system on chip, custom chip, etc.) and memory of any one or more types (e.g., RAM, ROM, cache, persistent, magnetic, bubble, etc.), with the memory storing machine-executable instructions encoding the method(s). As used herein and in the appended claims, the term “machine-readable storage medium” denotes hardware memory of any one or more types and does not include transitory signals, such as digital information encoded onto a carrier wave or into a pulsed signal.

### EXAMPLE EMBODIMENTS

With the foregoing in mind, this section describes some example embodiments that combine various features, elements, and components discussed above. These examples are not intended to cover all possible combinations and permutations of the features, elements, and components discussed above. Rather, they are simply illustrative of manners in which the foregoing features, elements, and component can be combined with one another and results that can be achieved therefrom.

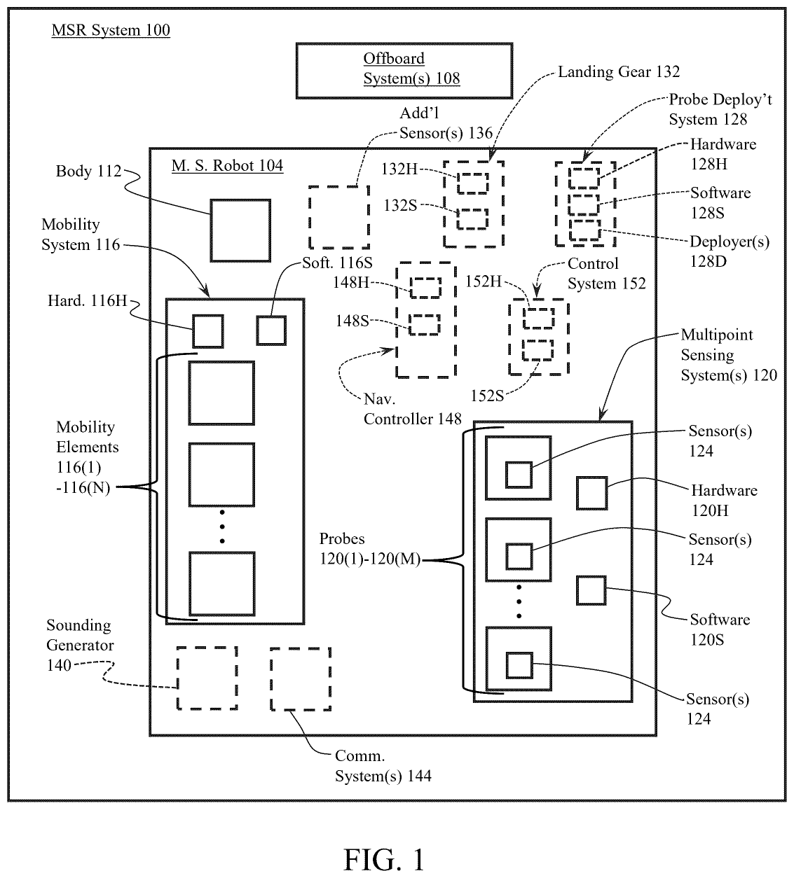

FIG. 1 shows an example mobile sensing robot (MSR) system 100 made in accordance with aspects of the present disclosure. As a preface to the following description of the MSR system 100 of this example, it is noted that the entirety of the descriptions of mobile sensing robots of the present disclosure in the General section above may be applied to corresponding features, aspects, elements, and functionalities of the MSR system 100 of FIG. 1, where explicitly stated in this current section or not.

The MSR system 100 of this example includes a mobile sensing robot 104 and any offboard system(s) 108 that may be needed to support the operation of the mobile sensing robot. The type and number of offboard system(s) 108 depend, for example, on the number of systems located onboard the mobile sensing robot 104. A number of examples of allocations of various systems as between the mobile sensing robot 104 and the offboard system(s) 108 are mentioned herein. However, those skilled in the art will readily understand that other allocations are possible, including allocations that include more or fewer systems than illustrated in FIG. 1.

In this example, the mobile sensing robot 104 includes a body 112 and a mobility system 116. As indicated in the General section above, the body 112 may comprise any suitable structure, such as a frame (unitary or articulated), a unibody construction, a platform (unitary or articulated), etc., to which the mobility system 116 and/or components thereof are attached or otherwise supported. Fundamentally, there are no limitations on the form and construction of the body 112. The mobility system 116 may be an airborne mobility system (e.g., rotor-type system, wing-type system, etc.) or a traction system (e.g., legged, wheeled, tracked, etc.), or a combination of an airborne mobility system and a traction system, having corresponding respective mobility elements 116 (1) through 116 (N), wherein N is an integer of 2 or more.

Depending on the type of mobility system 116, the traction elements may be an airborne mobility element (e.g., a rotor, propeller, flappable wing, etc.) or a traction element (e.g., leg, wheel, track, etc.) or a combination thereof (e.g., a wing may act as a leg). In addition to the mobility elements 116 (1) through 116 (N), the mobility system may have any necessary hardware 116H and software 116S needed to operate the mobility elements. Examples of hardware 116H include, but are not limited to, one or more actuators, one or more motors, one or more microprocessors, one or more digital-to-analog converters, one or more signal conditioners, and memory, among other things. The software 116S may be any suitable software for providing any necessary functionality to the mobility system.

The mobile sensing robot further includes one or more multipoint sensing systems 120 that includes a plurality of probes 120 (1) through 120 (M), wherein M is an integer of 2 or more. Each probe 120 (1) through 120 (M) includes one or more sensors 124. When multiple sensors 124 are provided, they may be of the same type or of differing types. In some embodiments, such as when the multipoint sensing system 120 is a vibration-sensing system, all of the probes 120 (1) through 120 (M) may be sensing probes. In some embodiments, such as when the multipoint sensing system 120 is an electrode-based sensing system, at least one of the probes 120 (1) through 120 (M) functions as a stimulus probe and at least one of the probes functions as a measuring probe when the stimulus is being provided. It is noted that, when the multipoint sensing system 120 is an electrode-based sensing system, any one or more of the probes 120 (1) through 120 (M) may be switchable between a stimulus probe and a measuring probe. In some embodiments, two or more multipoint sensing systems 120 of differing types may be provided. As alluded to above, when two or more multipoint sensing systems 120 of differing types are provided, one or more probes may function as a probe for some or all of the multipoint sensing systems. For example, if one of the multipoint sensing systems 120 is a vibration-sensing system and one of the multipoint sensing systems is a temperature-sensing system, the sensors 124 of any one or more of the probes 120 (1) through 120 (M) may include one or more vibration sensors and one or more temperature sensors. Many other possibilities exist with any types of suitable sensors.

Each multipoint sensing system 120 may include, as appropriate, any necessary hardware 120H and software 120S for operating that multipoint sensing system. Example hardware that can be used for the hardware 120H includes, but is not limited to, one or more digital processors, analog to digital converter(s), one or more signal conditioners, one or more stimulus devices (e.g., voltage generator, current generator), and one or more power sources (e.g., for powered sensors), among others. The software 120S may be any suitable software for controlling one or more functions of the multipoint sensing system 120.

As discussed above in the General section, one or more of the probes 120 (1) through 120 (M) may be deployed in or on one or more traction (mobility) elements 116 (1) through 116 (N), for example, in a one-to-one or another manner or any other suitable manner. In some embodiments, one or more of the probes 120 (1) through 120 (M) may not be deployed on any corresponding traction (mobility) element 116 (1) through 116 (N). For example, such embodiments may have either a probe deployment system 128 having one or more optional probe deployers (singly and collectively represented at element 128D) or optional landing gear 132 if the mobility system 116 includes an airborne mobility system. Some embodiments may include both one or more optional probe deployers and optional landing gear. Examples of probe deployers and landing gear suitable for use as, respectively, the optional probe deployer(s) 128D and the optional landing gear 132 are mentioned in the General section above. Each of the probe deployment system 128 and the landing gear 132, if provided, may have any necessary hardware 128H, 132H and software 128S, 132S needed to operate the corresponding probe deployment system and landing gear. Examples of hardware 128H and 132H include, but are not limited to, one or more actuators, one or more microprocessors, one or more digital-to-analog converters, one or more signal conditioners, and memory, among other things. The software 128S and 132S may be any suitable software for providing any necessary functionality to the respective one of the probe deployment system 128 and the landing gear 132.

In some embodiments, the mobile sensing robot 104 may include one or more additional sensors, which are singly and collectively represented at element 136 in FIG. 1. Each additional sensor 136 may be provided for any necessary/desired purpose, such as to complement the sensing performed by each multipoint sensing system provided, to provide visual information for human-assisted navigation of the multipoint sensing robot, or to provide environmental information for semi-automated or fully automated navigation, among other things. Examples of additional sensors that can be used for any additional sensor 136 are described in the General section above and include, but are not limited to, visible-light cameras, infrared cameras, forward looking radar units, laser rangers, light detection and ranging units, ultrasound units, thermometers, barometers, hygrometers, air-quality sensors, gas-detection sensors, electromagnetic field sensors, radiation sensors, and smoke detectors, among many others. Those skilled in the art will readily appreciate the number and type of additional sensors 136 needed for a particular instantiation of the mobile sensing robot 104.

If any of the multipoint sensing systems 120 aboard the mobile sensing robot 104 is a vibration-sensing system, the mobile sensing robot may optionally include a sounding generator 140 of any suitable type, such as any of the types noted above in the General section.

In some embodiments, the mobile sensing robot 104 may include one or more communications systems, singly and collectively represented in FIG. 1 at element 144, for enabling one-or two-way communications between the mobile sensing robot and one or more offboard systems 108. Each communications system 144 may be any suitable wireless or wired communications system. Example wireless communications systems include radio-frequency communications systems, light-based communications systems (e.g., infrared), and sound-based communications systems (e.g., ultrasound). Example wired communications systems include any tether-type communications system based on any suitable wired communications standard.

In some embodiments, the mobile sensing robot 104 may include a navigation controller 148 that can be configured to provide navigation functionality to the mobile sensing robot. As alluded to above in the General section, the mobile sensing robot 104 can be provided with any one or more desired levels of navigation functionality, from fully human guided, to semi-autonomous, to fully autonomous, and the navigation controller 148 is configured to provide the requisite functionality (ies) for enabling these functionalities. In this connection, the navigation controller 148 may include any suitable hardware 148H and software 148S needed to enable these functionalities. Consequently, the navigation controller 148 may be in operative communication, as needed or as available, with any one or more of the mobility system 116, one or more multipoint sensing systems 120, one or more additional sensors 136, landing gear 132, and one or more of the communications systems 144, among other things. Further details and examples of navigation are described in the General section above. Like other hardware aboard the mobile sensing robot 104, the hardware 148H provided may be dedicated to the navigation controller 148 or it may be shared with one or more other systems aboard the mobile sensing robot, such as the mobility system 116, the multipoint measurement system(s) 120, the probe-deployment system 128, and the communications system 144, as may be available or make practical sense.

In some embodiments, the mobile sensing robot 104 includes a control system 152 that may act as a central controller aboard the mobile sensing robot to coordinate operations of any two or more other components aboard the mobile sensing robot, such as the navigation controller 148, the mobility system 116, the multipoint sensing system(s) 120, the probe-deployment system 128, and the communications system 144. The control system 152 may include hardware 152H, for executing software 152S, that is separate from or shared with one or more other components aboard the mobile sensing robot, such as the navigation controller 148, the mobility system 116, the multipoint sensing system(s) 120, the probe-deployment system 128, and the communications system 144, as may be available or make practical sense.

In an example, the offboard system(s) 108 may include any one or more consoles that allows a human user to perform any one or more of the following example tasks: view measurement data that the mobile sensing robot 104 acquires, view images provided by the mobile sensing robot, control movement of the mobile sensing robot, input and higher-level navigation commands to the mobile sensing robot, control operation of each multipoint sensing system 120, control operation of the probe-deployment system 128, control operation of any additional sensor 136, and control operation of the sounding generator 140, among other things. Each console may be any suitable device, such as a laptop computer, a desktop computer, a cloud-connected device, a tablet computer, augmented reality headset, a dedicated console, etc. The console may be in communications with the mobile sensing robot 104 via any one or more of the communications systems 144. It is noted that while much of the computing and control capabilities of the example mobile sensing robot 104 is located aboard the mobile sensing robot, depending on the speed of the communications between the offboard system(s) 108 and the mobile sensing robot, at least some of the computing and control capabilities may be provided in the offboard system(s). Not shown but will be present in non-tethered embodiments, are one or more power sources, such as batteries, aboard the mobile sensing robot 104 for powering one or more of the various components aboard the mobile sensing robot.

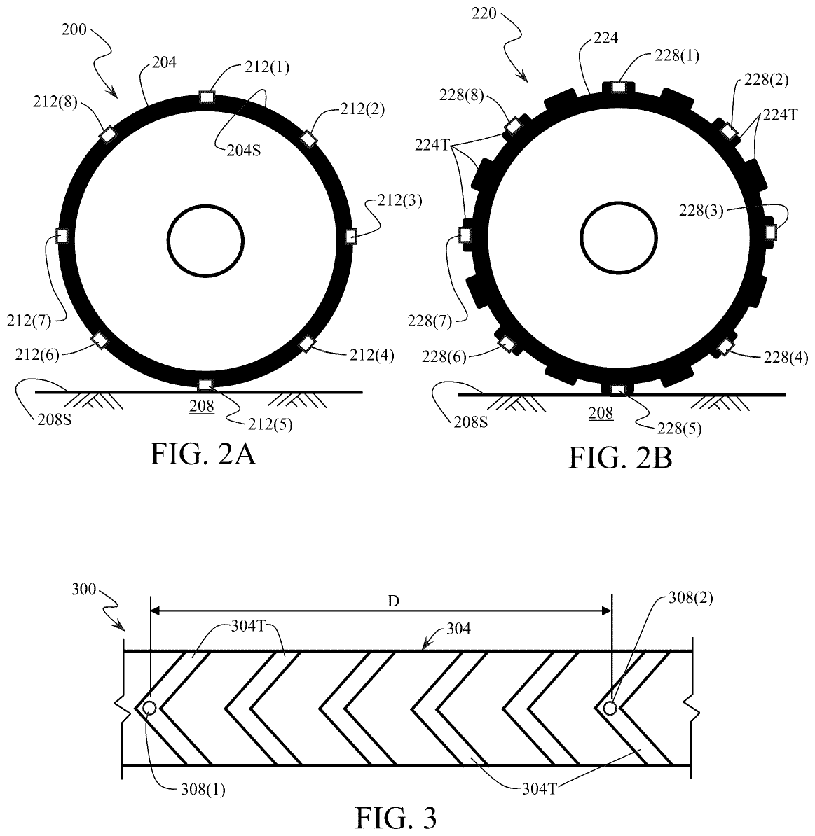

FIG. 2A shows an example wheel-type traction element 200 that has a smooth traction surface 204S that engages a surface 208S of a material 208 when the wheel-type traction element traverses the surface 208S. In this example, the wheel-type traction element 200 has a plurality of probes 212 (1) through 212 (8) distributed evenly around its circumference. The probes 212 (1) through 212 (8) may all be the same as one another or they may be of two or more differing types. Each probe 212 (1) through 212 (8) may be of any suitable type, such as any of the types mentioned in this disclosure. In an example, the traction surface 204S is on a traction layer 204 composed of a rubber or other material that provides the requisite compliance and/or friction needed for proper traction. Each probe 212 (1) through 212 (8) may be mounted in or on the traction layer 204. Optionally, each probe 212 (1) through 212 (8) may be biased into engagement with the surface 208S by a suitable biasing member (not shown), such as a spring or compliant pad located within a recess in the traction layer. More of fewer probes 212 (1) through 212 (8) may be provided in other embodiments. Many other wheel constructions are possible. FIG. 2B shows another example wheel-type traction element 220. This example is similar to the example of FIG. 2A except that the traction layer 224 of FIG. 2B has treads 224T (only a few labeled to avoid clutter) that engage the surface 208S of the material 208, and the probes 228 (1) through 228 (8) are located on or in corresponding ones of the treads. All other aspects of the wheel-type traction element 220 of FIG. 2B may be the same as or similar to the wheel-type traction element 200 of FIG. 2A.

FIG. 3 shows an example track-type traction element 300 that includes a track 304 having treads 304T (only some labeled to avoid clutter). In this example, the track-type traction element 300 includes two probes 308 (1) and 308 (2), which may be of the same type or differing types. As can be readily appreciated, when both probes 308 (1) and 308 (2) are in their sensing positions confronting a measurement surface (not shown), the distance, D, between the two probes is fixed and known. Having such a fixed, known distance D can be useful for certain types of measurements, such as determining an offset in timing of vibrations between the two probes 308 (1) and 308 (2) or electrical measurements between a stimulus electrode and a measuring electrode, among others. Aspects of the track 304 and the probes 308 (1) and 308 (2) may be the same as or similar to like aspects described above relative to the wheel-type traction elements 200 and 220 of FIGS. 2A and 2B, respectively.

FIG. 4 illustrates an example mobile sensing robot 400 that is a quadra-ped robot having a body 404 and four controllable articulating legs 408 (1) through 408 (4) that are part of a larger traction system 408 that includes various components that are not seen as they are located inside of the legs and the body. Such unseen components include, but are not limited to, motors, actuators, position sensors, cabling, and control system, among others. Such components are known in the fields of articulating-leg robotics and need not be described further for those skilled in the art to understand how to make the example mobile sensing robot 400 from the present description. In this example, each leg 408 (1) through 408 (4) includes a corresponding foot 408F (1) through 408F (4), and integrated into each foot is a corresponding piezoelectric vibration sensor 412 (1) through 412 (4) (only vibration sensors 412 (1) and 412 (2) are seen, and vibration sensor 412 (1) is shown in an exploded fashion relative to the corresponding foot 408F (1)). With the integration of the vibration sensors 412 (1) through 412 (4) into the corresponding feet 408F (1) through 408F (4), each foot or entire leg 408 (1) through 408 (4) may be considered to be a probe as this term is used herein and in the appended claims. The vibration sensors 412 (1) through 412 (4) and corresponding probes are parts of a multipoint vibration-sensing system 412 that may further include other components not seen, such as circuitry and other hardware hidden within the body 404 and legs 408 (1) through 408 (4).

In this embodiment, the mobile sensing robot 400 includes a visible-light camera 416 that a remote human operator (not shown) uses to view the environment of the mobile sensing robot. For example, the human operator may use a console (not shown) to input and issue navigation commands to the mobile sensing robot 400, which may have a suitable navigation controller (not shown; hidden from view), which may be the same as or similar to the navigation controller 148 of FIG. 1. In an example, the console may include an augmented reality system that allows the human operator to contextualize the location of the mobile sensing robot 400 in the environment in which it is operating.

In the example shown, the mobile sensing robot 400 includes a sounding generator 420, which in this case comprises a controllable articulated arm 424 having a gripper 424G that grips a tapping mechanism (not shown) that impacts the material (not shown) or a weight (not shown) that the arm drops so that the weight impacts the surface below in order to induce vibrations into the material (not shown) on which the mobile sensing robot is standing. In an example, the arm 424 is extended as far forward of the camera 416 as possible before the gripper 424G releases the weight. After the sounding generator 420 has dropped the weight and two or more of the vibration sensors 412 (1) through 412 (4) have obtained corresponding vibration measurements, the arm 424 may be controlled to retrieve the weight and return the arm to its retracted position. In some embodiments, the dropping and retrieval of the weight may be automated or manually controlled by a remote human operator. Other aspects and features of the mobile sensing robot 400 may be the same as or similar to like features described above. In addition, many modifications of the mobile sensing robot of FIG. 4 will be evident to those skilled in the art, especially in view of the descriptions of many variants above.

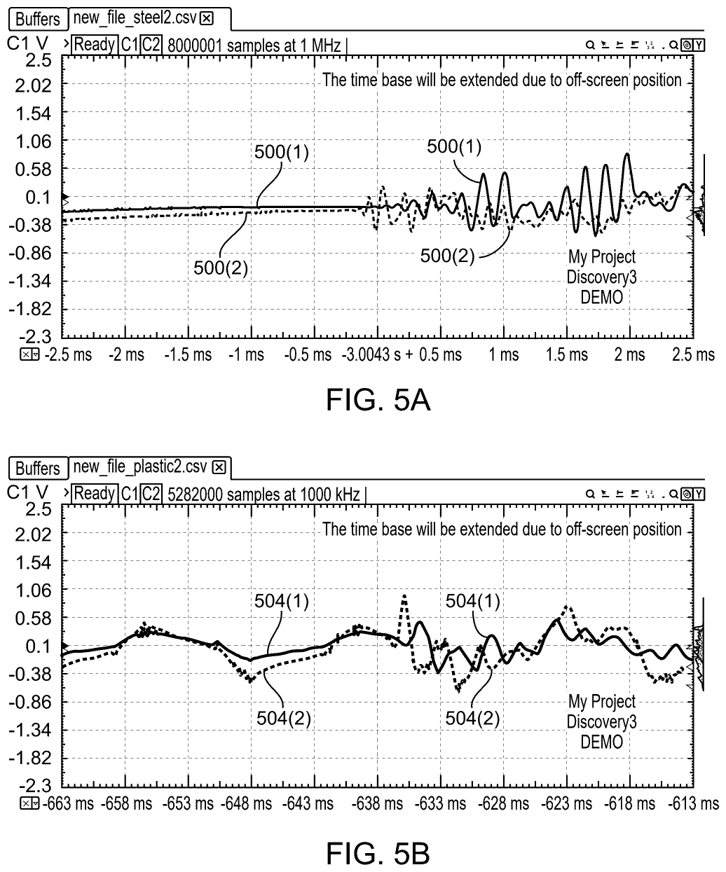

FIG. 5A illustrates the wave propagation along a steel measurement surface cause by the impact of the tapping mechanism described above in connection with FIG. 4, onto the steel surface, as sensed at two different spaced-apart locations, for example, at the sensors 412 (1) and 412 (2) on the feet 408 (1) and 408 (2) of the mobile sensing robot 400 of FIG. 4. As can be seen from the two differing sensor-signal plots 500 (1) and 500 (2) in FIG. 5A, there is a time delay between detection of the wave at the two spaced-apart sensors. This time delay can be used to determine the properties of the material and/or the directionality of the wave. Similarly, FIG. 5B illustrates the wave propagation along a plastic measurement surface cause by the impact of the tapping mechanism described above in connection with FIG. 4, onto the plastic surface, as sensed at two different spaced-apart locations, for example, at the sensors 412 (1) and 412 (2) on the feet 408 (1) and 408 (2) of the mobile sensing robot 400 of FIG. 4. As can be seen from the two differing sensor-signal plots 504 (1) and 504 (2) in FIG. 5B, there is a time delay between detection of the wave at the two spaced-apart sensors. This time delay can be used to determine the properties of the material and/or the directionality of the wave.

Example use cases for mobile sensing robots of the present disclosure include, but are not limited to, the following uses cases.
Emergency Personnel Assistance: One or more mobile sensing robots of the present disclosure can be used to assess the integrity of structural systems (e.g., floors, walls, columns, stairways, etc.) on a rapid and real-time basis to assist emergency personnel (e.g., firefighters, emergency medical personnel, first responders, etc.), for example, when such personnel are searching a building or other structure for victims of disasters (e.g., fires, earthquakes, tornados, hurricanes, bombings, etc.). For example, each mobile sensing robot may be outfitted with one or more of a variety of suitable sensors for measuring the integrity of the structure system(s) at issue, such as sounding sensors, ultrasonic sensors, radar sensors, capacitance sensors, and electrical resistance sensors, among others.
Subsurface Utility Locating: One or more mobile sensing robots of the present disclosure can be used to locate subsurface utilities, such as, but not limited to, underground utilities (e.g., gas piping, water piping, sewer piping, electrical conduit, etc.) and/or similar utilities and other subsurface structures/components within building walls, ceilings, floors, etc. For example, each sensing robot may include one or more of a variety of suitable sensors for detecting location and/or depth of one or more utilities, such as, ultrasonic sensors, radar sensors, thermal sensors, electrical field sensors, and/or magnetic sensors, among others.
Subsurface Utility Status/State Detection: One or more mobile sensing robots of the present disclosure can be used to detect an operating status/state of subsurface utilities (e.g., gas piping, water piping, sewer piping, electrical conduit, etc.), such as leak detection, pipe-flow detection, and/or live/dead electrical conduit detection, among others. For example, each sensing robot may include one or more of a variety of suitable sensors for detecting the status/state of one or more utilities, such as, electronic noses, capacitance sensors, electrical resistance sensors, moisture sensors, sonic sensors, thermal sensors, electrical field sensors, magnetic sensors, ultrasonic sensors, and radar sensors, among others.
Moving Object Detection/Location: One or more mobile sensing robots of the present disclosure can be used to detect and/or locate one or more moving objects (e.g., vehicles, humans, animals, etc.). For example, each sensing robot may include one or more of a variety of suitable sensors for detecting the state of one or more utilities, such as, one or more image sensors (e.g., visible light, NIR, etc.) motion detectors, audio sensors, and/or electronic noses, among others.
Subsurface Tunnel Detection: One or more mobile sensing robots of the present disclosure can be used to detect and/or locate subsurface tunnels. For example, each sensing robot may include one or more of a variety of suitable sensors for detecting and/or locating subsurface tunnels, such as, sounding sensors, ultrasonic sensors, ground-penetrating radar sensors, thermal sensors, electrical field sensors, and/or magnetic sensors, among others.
Mine Integrity Assessment: One or more mobile sensing robots of the present disclosure can be used to assess the integrity of a mine, tunnel, burrowing, etc., on a rapid and real-time basis. For example, each mobile sensing robot may be outfitted with one or more of a variety of suitable sensors for measuring the integrity of the structure system(s) at issue, such as sounding sensors, ultrasonic sensors, ground-penetrating radar sensors, capacitance sensors, and electrical resistance sensors, among others.
Valuable Mineral Prospecting: One or more mobile sensing robots of the present disclosure can be used to detect/locate one or more valuable minerals (e.g., iron ore, lithium, copper, gold silver, uranium, nickel, magnesium, cobalt, etc.). For example, each mobile sensing robot may be outfitted with one or more of a variety of suitable sensors for detecting the mineral(s) at issue, such as sounding sensors, ultrasonic sensors, ground-penetrating radar sensors, capacitance sensors, and electrical resistance sensors, magnetic sensors, electrical field sensors, and radiation detectors, among others.
Underground Water Prospecting: One or more mobile sensing robots of the present disclosure can be used to detect/locate underground water. For example, each mobile sensing robot may be outfitted with one or more of a variety of suitable sensors for detecting water, such as sounding sensors, ultrasonic sensors, ground-penetrating radar sensors, capacitance sensors, and electrical resistance sensors, magnetic sensors, electrical field sensors, and moisture sensors, among others.

As noted above, a mobile sensing robot of the present disclosure can be programmed to determining directionality of increasing and/or decreasing structural soundness, such as in the use case of determining structural integrity and/or structural damage. In some cases, a mobile sensing robot may locate the source(s) of structure damage based on such directionality awareness. In some cases, a mobile sensing robot may determine the source(s) of structural damage via its ability to perform autonomous surveying via suitable automated or semiautomated control. As also noted above, an actuator and/or probe on a mobile sensing robot may be operated to create a change in a property at a single point for making one or more surface measurements at one or more corresponding locations with one or more suitable sensors. For example, the mobile sensing robot may make a sounding disturbance (impact, vibratory, ultrasonic, etc.) at a first location while measuring the structure's response at one or more other locations. As another example, the mobile sensing robot may apply an electrical signal at a first location while measuring a corresponding response electrical signal at each of one or more other locations. Those skilled in the art will readily appreciate the many types of probing-type tests and measurements can be performed.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. (canceled)

2. A mobile sensing robot for traversing a surface of a material, the mobile sensing robot comprising:
a body,
a mobility system engaged with the body, the mobility system designed and configured to move the mobile sensing robot relative to the surface when the mobile sensing robot is deployed for use; and
a multipoint sensing system operatively coupled to the body, the multipoint sensing system including a plurality of probes each configured to be intermittently deployed into contact with the surface at corresponding respective spaced-apart locations on the surface so that the probes can be used to acquire measurement data of a characteristic of the material and of directionality of change in the characteristic of the material;
a control system located aboard the mobile sensing robot and operatively coupled with:
the mobility system; and
the multipoint sensor system so as to control operation of the plurality of probes; and
a navigation controller that uses the directionality of change in the characteristic of the material to instruct the control system to control the mobility system so as to move the mobile sensing robot to a next sensing location.

3. The mobile sensing robot of claim 2, wherein the mobility system comprises an airborne mobility system for moving the mobile sensing robot to or proximate to the surface of the material at the next sensing location.

4. The mobile sensing robot of claim 2, wherein the mobility system comprises a submersible propulsion system for maneuvering the mobile sensing robot in a liquid.

5. The mobile sensing robot of claim 2, wherein the mobility system comprises a traction system that includes a plurality of traction elements that engage the surface when the mobile sensing robot is deployed for use and, when operated, cause the mobile sensing robot to move on the surface to the next sensing location.

6. The mobile sensing robot of claim 2, wherein the mobility system has a plurality of contact points that contact the surface during use of the mobility system, and the plurality of probes are located in or on the contact points.

7. The mobile sensing robot of claim 2, wherein the multipoint sensing system comprises a vibration sensing system, and at least three of the plurality of probes comprise vibration sensors.

8. The mobile sensing robot of claim 7, further comprising a sounding system operatively configured to generate a sounding, wherein the control system is operatively configured to control the sounding system.

9. The mobile sensing robot of claim 2, wherein the multipoint sensing system comprises an electrical resistance sensing system, and the plurality of probes includes at least one stimulus electrode and at least one electrical measurement electrode.

10. The mobile sensing robot of claim 2, wherein the multipoint sensing system comprises an electrical resistance sensing system, and the plurality of probes includes at least two stimulus electrodes and at least two electrical measurement electrodes.

11. The mobile sensing robot of claim 2, wherein the navigation controller includes a semi-autonomous navigation controller configured to receive and respond to gross navigation commands from offboard the mobile sensing robot and to generate and respond to measurement-based navigation commands based, at least in part, on the directionality of the change in the characteristic of the material.

12. The mobile sensing robot of claim 11, wherein:
the characteristic is soundness of the material; and
the semi-autonomous navigation controller is designed and configured to generate the measurement-based navigation commands as a function of a directionality of changes in the soundness of the material.

13. The mobile sensing robot of claim 12, wherein the material comprises a structural building material.

14. The mobile sensing robot of claim 11, wherein the plurality of probes includes three or more vibration sensors, and the semi-autonomous navigation controller is designed and configured to determine the directionality based on a plurality of timing differences between three or more measurements acquired substantially simultaneously by the three or more vibration sensors.

15. The mobile sensing robot of claim 11, wherein:
the characteristic is electrical resistance within the material; and
the semi-autonomous navigation controller is designed and configured to generate the measurement-based navigation commands as a function of the directionality of change in the electrical resistance of the material.

16. The mobile sensing robot of claim 15, wherein the material comprises a structural building material.

17. The mobile sensing robot of claim 11, wherein the plurality of probes includes at least one stimulus electrode and two or more measuring electrodes, and the semi-autonomous navigation controller is designed and configured to determine the directionality based on a plurality of timing differences between two or more measurements acquired substantially simultaneously by the two or more measuring electrodes.

18. The mobile sensing robot of claim 17, wherein:
the characteristic is electrical impedance within the material; and
the semi-autonomous navigation controller is designed and configured to generate the measurement-based navigation commands as a function of the directionality of changes in the electrical impedance of the material.

19. The mobile sensing robot of claim 18, wherein the material comprises a structural building material.

20. The mobile sensing robot of claim 18, wherein the plurality of probes includes at least one stimulus electrode and two or more measuring electrodes, and the semi-autonomous navigation controller is designed and configured to determine the directionality based on a plurality of timing differences between two or more measurements acquired substantially simultaneously by the two or more measuring electrodes.

21. The mobile sensing robot of claim 2, further comprising a measurement system configured to determine at least one property of the material as a function of timing differences between two or more measurements acquired substantially simultaneously by two or more of the probes.
